(19) United States
(12) Patent Application Publication
(10) Pub. No.: US 2012/0284275 A1
(43) Pub. Date: Nov. 8, 2012

(54) UTILIZING OFFLINE CLUSTERS FOR REALTIME CLUSTERING OF SEARCH RESULTS

(76) Inventors: Srinivas Vadrevu, Milpitas, CA (US); Choon Hui Teo, Sunnyvale, CA (US); Suju Rajan, Sunnyvale, CA (US); Kunal Punera, Santa Clara, CA (US); Byron E. Dom, Los Gatos, CA (US); Alex J. Smola, Sunnyvale, CA (US)

(21) Appl. No.: 13/099,197

(22) Filed: May 2, 2011

(51) Int. Cl. G06F 17/30

(52) U.S. Cl. 707/738; 707/737; 707/E17.014; 707/E17.008

(57) ABSTRACT

Techniques for clustering of search results are described. In an example embodiment, a plurality of first clusters is determined, in a corpus of articles, independently of user queries issued against the corpus of articles, where each first cluster represents a group of articles that relate to a news story. One or more cluster identifiers are assigned to each article in the corpus, where the one or more cluster identifiers respectively identify one or more of the plurality of first clusters to which the article belongs. A query that specifies search criteria against the corpus of articles is received. In response to receiving the query, a result for the query is generated by at least selecting, from the corpus of articles, a set of articles based on the search criteria. The selected set of articles is grouped into one or more second clusters based at least on the one or more cluster identifiers that are assigned to each article in the set of articles. In the result for the query, the set of articles is organized according to the one or more second clusters.

### CROSS-REFERENCE TO RELATED APPLICATIONS

This application is related to U.S. application Ser. No. 12/835,954, filed on Jul. 14, 2010 by Srinivas Vadrevu et al. and titled “CLUSTERING OF SEARCH RESULTS”, the entire contents of which is hereby incorporated by reference as if fully set forth herein.

### TECHNICAL FIELD

The present disclosure relates to clustering of search results.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

To search for information about a topic on the Internet, a user typically uses a web browser or similar program to send a search query to a web search engine. The search query typically includes a few words or search terms that describe the topic of interest. The search engine performs a search based on the search query against a search index, and returns a search result to the user's browser. The search result is typically included in a dynamically generated web page and comprises a list of Uniform Resource Locator (URL) links to various electronic documents and/or other network resources that match, or a relevant to, the terms of the search query. In addition to the list of URL links, the search engine may also provide in the search result a short summary for each of documents identified in the URL links.

A search engine may also organize the list of URL links in a format that is more suitable for review by the user. For example, the search engine may provide a unified view of the search result by grouping together URL links that point to similar documents. This allows the user to examine the groups or categories of documents identified in the search result without having to click on, access, and individually review all of the documents pointed to by the URL links.

In some approaches, a search engine may use information from various portions of the documents identified in the search result in order to more accurately identify which documents have similar contents. Unfortunately, however, a significant disadvantage of these approaches is that the processing latency increases dramatically when even a modest amount of additional information from the bodies of the documents is used to determine whether any documents have similar contents. For example, a search engine must determine the search result, determine the similar documents in the result, and group together the similar documents at runtime after a user issues a search query. However, the search engine only has a very short amount of time (e.g., a few microseconds) to perform all this processing in real-time since users typically do not like to wait a significant amount of time before receiving the search results for their search queries.

### BRIEF DESCRIPTION OF THE DRAWINGS

The techniques described herein are illustrated by way of example, and not by way of limitation, in the figures of the accompanying drawings and in which like reference numerals refer to similar elements and in which:

FIG. 1 is a flow diagram that illustrates an example method for clustering of search according to one embodiment;

FIG. 2 is a block diagram that illustrates an example of a clustered search result according to one embodiment;

FIG. 3 is a block diagram that illustrates an example operational context according to one embodiment; and

FIG. 4 is a block diagram that illustrates an example computing device on which embodiments may be implemented.

### DETAILED DESCRIPTION

In the following description, for the purposes of explanation, numerous specific details are set forth in order to provide a thorough understanding of the described techniques for clustering of search results. It will be apparent, however, that the techniques described herein may be practiced without these specific details. In other instances, well-known structures and devices are shown in block diagram form in order to avoid unnecessarily obscuring the techniques described herein.

### GENERAL OVERVIEW

Techniques for real-time clustering are described herein. According to these techniques, clusters (with possibly different granularity) are computed offline over a set of documents, and then cluster identifiers of these offline clusters are used as proxies for content from the bodies of the documents during online clustering that is performed in response to a user query. For example, the offline cluster identifiers, which are assigned to the documents included in the search result for a user query, are used in computing similarity values that measure the closeness between pairs of the result documents, and the computed similarity values are then used to determine (at least in part) the final, online clusters according to which the search result is organized.

In an example embodiment, the techniques for clustering of search results described herein may be implemented as a method comprising the computer-implemented steps of: determining a plurality of first clusters in a corpus of articles, where each of the plurality of first clusters represents a group of articles that relate to a news story, and where determining the plurality of first clusters is performed independently of user queries issued against the corpus of articles; assigning one or more cluster identifiers to each article in the corpus of articles, where the one or more cluster identifiers respectively identify one or more of the plurality of first clusters to which said each article belongs; receiving a query that specifies one or more search criteria against the corpus of articles; in response to receiving the query, generating a result for the query by at least selecting, from the corpus of articles, a set of articles based on the one or more search criteria specified in the query; grouping the set of articles into one or more second clusters based at least on the one or more cluster identifiers that are assigned to each article in the set of articles; and in the result for the query, organizing the set of articles according to the one or more second clusters. In this manner, the techniques described herein provide for lower or minimal processing latency during runtime when the search result for a user query is generated, while at the same time improving the accuracy of the clustering of the search result by taking into account offline cluster identifiers that represent features and content from the bodies of the documents identified in the search result.

In various embodiments, the techniques described herein may be implemented as one or more methods that are performed by one or more computing devices, as a computer program product in the form of sequences of executable instructions that are stored on one or more computer-readable storage media, and/or as one or more computer systems that are configured to perform clustering of search results as described herein.

### Functional Description of an Example Embodiment

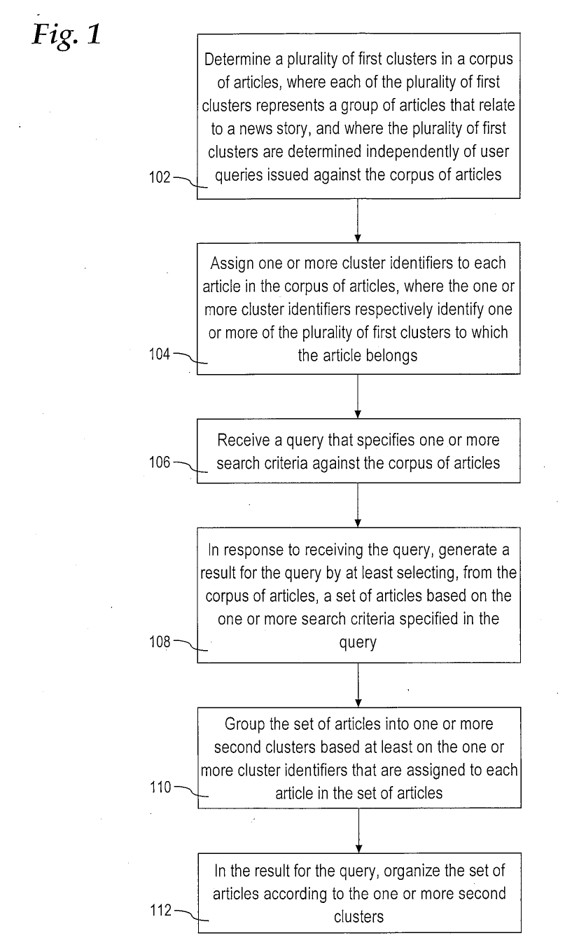

FIG. 1 is a flow diagram that illustrates an example method for clustering of search results in accordance with the techniques described herein.

In some embodiments, the steps of the method illustrated in FIG. 1 are performed by a component that is included in, or is associated with, a search engine that is executing on one or more computing devices. As used herein, “search engine” refers to one or more software components which, when executed, may be allocated computational resources, such as memory, CPU time, and/or disk storage space in order to perform one or more functionalities that include, but are not limited to, crawling one or more public (e.g., the Internet) and/or private networks to locate content stored on network nodes therein, indexing the located content into one or more search indexes, and responding to user queries based on the search indexes. In some embodiments, the steps of the method illustrated in FIG. 1 may be performed by computer process entities other than search engine-related components including, but not limited to, background processes or threads, daemon processes, and any other types of suitable system services or servers.

The method illustrated in FIG. 1 is described hereinafter as being performed by one or more clustering components in association with a search engine that are included in a (possibly distributed) system. However, it is noted that the method of FIG. 1 is not limited to being performed by any particular type of component or any particular type of computer process entity or service.

In step 102, an offline clustering component performs offline clustering to determine a plurality of offline clusters in a corpus of articles, where each of the plurality of offline clusters represents a group of articles that relate to a news story. As used herein, “article” refers to an electronic document that stores certain content. Examples of articles include, without limitation, files formatted in a markup language (e.g., HTML files, XML files, etc.), portions or sections of a web feed (e.g., such as a RSS feed), and any other types of files and structured data sets that are suitable for storing content. “Cluster” refers to a group or grouping of articles that have similar content, where the similarity between the content of the articles in a cluster is defined by a particular similarity threshold.

As used herein, “news story” refers to a real-world event that is defined by a specific set of facts. For example, a news story may be defined by a set of facts that include anything about the earthquake in Haiti. In another example, a news story may be defined by a set of facts that relate specifically to aftershocks in the Haiti earthquake. In yet another example, a news story may be defined by a set of facts that relate specifically to rescue efforts that are being, and/or were conducted, in the aftermath of the Haiti earthquake. Since the different levels of detail or granularity in different sets of facts may define multiple different news stories, the particular set of facts described in a particular article can indicate that the particular article describes (and/or is related to) multiple different news stories.

As used herein, “offline clustering” refers to computer-implemented processing that groups a corpus (or a large set) of articles into clusters based on the similarity of the content of the articles. Offline clustering is performed independently of user queries that are issued against a corpus of articles, and is typically performed against substantially the whole corpus. Offline clustering against a corpus of articles can be performed periodically (e.g., every N number of hours, every day, every week) and/or incrementally as articles become available and are included in the corpus.

In step 104, the offline clustering component assigns one or more cluster identifiers to each article in the corpus of articles. The cluster identifier(s) assigned to a particular article identify those offline cluster(s) to which the particular article belongs as determined by the offline clustering. For example, if the offline clustering determined that article A belongs to clusters X, Y, and Z, the IDs of clusters X, Y, and Z are assigned to article A and are stored in association with article A itself and/or with an article ID that identifies the article.

In step 106, a search engine associated with the offline clustering component receives a query that specifies one or more search criteria against the corpus of articles. For example, the search engine may receive the query from a web browser, where a user of the web browser has entered one or more search terms (e.g., words or phrases that comprise the search criteria of the query) in a web page or other interface provided by the search engine.

In response to receiving the query, in step 108 the search engine generates a search result for the query based on the search criteria specified in the query. In an example implementation, the search engine performs a search or a lookup against a search index in order to identify those articles, from the corpus of articles, that match or are relevant to the search terms specified in the query. The search engine then uses a ranking function to rank each identified article, and selects a certain set (e.g., top 100) of the identified articles as the search result for the query.

In step 110, an online clustering component performs online clustering over the set of articles, which are selected by the search engine in the result for the query, in order to determine one or more online clusters to which the selected articles belong. As used herein, “online clustering” refers to computer-implemented processing that groups a set of articles, in the search result for a query, into clusters based on the similarity of the content of the articles. Online clustering is typically performed in response to a query and only over the set of those articles which are identified in the search result for the query.

Specifically, according to the techniques described herein, in step 110 the online clustering component uses at least the offline cluster identifier(s) that are assigned to each of the set of articles, in the search result for the query, to group the set of articles into one or more online clusters. In an example implementation, the online clustering component constructs a vector (e.g., an ordered sequence of values) for each article in the set of articles included in the search result, where the vector representing a particular article includes at least the offline cluster identifier(s) that are assigned to the particular article and that identify the offline cluster(s) to which the particular article belongs. In some embodiments, in addition to using offline cluster identifiers that are assigned to each of the set of articles included in the search result for the query, the online clustering component may also use information from the title the abstract of each article when constructing the vector representing that article. After constructing the vectors representing the set of articles in the search result for the query, the online clustering component uses the vectors to determine one or more online clusters to which these articles belong.

In step 112, the online clustering component (or another component associated with the search engine) organizes the set of articles included in the result for the query according to the determined one or more online clusters. In an example implementation, the online clustering component dynamically generates a web page that includes a list of URL links to the articles included in the search result for the query. By using suitable indentation and spacing, the web page is formatted so that URL links to articles that belong to the same online cluster appear together and so that different clusters' links are grouped separately from each other. The online clustering component (or another component associated with the search engine) then returns the generated web page to the web browser or other program that sent the original query.

In this manner, the techniques described herein significantly improve the accuracy of the clustering in the search results for user queries, while at the same time causing no or only minimal increase in the processing latency of the online clustering. Specifically, when determining the online clusters for the articles in the search result for a query, the techniques described herein can account for the specific level of detail or granularity indicated in the query by using information from the titles and abstracts of the articles included in the search result, while at the same time improving the accuracy of the online clustering at no or minimal processing cost by using the offline cluster identifiers assigned to the articles as proxies for the content in the bodies of these articles.

### Offline Clustering

According to the techniques described herein, offline clustering is performed on a corpus of articles to determine the clusters to which the articles in the corpus belong. The cluster identifiers, which uniquely identify the offline clusters, are then assigned to the articles in corpus, where each article (and/or an identifier thereof) is associated with the cluster identifiers of those offline clusters to which the article belongs.

In an example embodiment, an offline clustering component uses a Locality Sensitive Hashing (LSH) mechanism to perform offline clustering that computes similarity values between pairs of articles in a corpus of articles. As used herein, “similarity value” refers to a value that indicates how close to each other are the contents of two articles. For example, a similarity value may be a real number between “0.0” and “1.0”, where “0.0” indicates completely different content and “1.0” indicates exactly the same content.

In the example embodiment, after using the LSH mechanism to determine the pair-wise similarity values for the pairs of articles in the corpus, the offline clustering component constructs a similarity graph on the corpus, where for a particular pair of articles the graph includes an edge if the similarity value between the two articles in the pair meets a threshold. The organization and the accuracy of the similarity graph depend at least in part on the how the similarity thresholds are defined or configured. For example, defining or configuring threshold values that are too low may cause false edges to be added to the graph thereby grouping together articles that are not in fact similar, while defining or configuring threshold values that are too high may cause additional edges to be added to the graph thereby splitting into different clusters articles that actually relate to the same news story.

After constructing the similarity graph, the offline clustering component runs a correlation clustering mechanism to partition the graph into clusters, thereby producing the final offline clusters. In an example implementation, the correlation clustering mechanism uses a randomized algorithm that attempts to minimize a cost function based on the number of dissimilar pairs of articles in the same cluster and on the number of similar pairs in different clusters. As clustering proceeds, the randomized algorithm takes into account weights, which are assigned to graph edges that are cut or formed, as part of the cost function. Since the randomized algorithm may be sensitive to the initialization data point, the correlation clustering mechanism is run multiple times with different random seeds. The final offline clusters are selected as the output from the multiple runs which produced the lowest value for the cost function. It is noted that the use of this correlation clustering mechanism does not require the configuration of a pre-determined number of clusters, which is beneficial in the context of news article clustering since it is not easy to guess the number of clusters in an evolving news corpus in which a major news event can trigger multiple articles over a few days.

According to the techniques described herein, each article in the corpus may be assigned to belong to multiple different clusters that are identified by different cluster identifiers. In one example, the same offline clustering mechanism (e.g., such as LSH, minhash signature mechanism, textual matching mechanism, contextual term weighting, etc.) may be performed multiple times against the corpus of articles with multiple different similarity thresholds, thereby by assigning each article in the corpus into multiple different offline clusters. In another example, multiple different clustering mechanisms that use different algorithms may be performed against the corpus of articles, thereby also assigning each article in the corpus into multiple different offline clusters. Thus, the techniques described herein provide for assigning each article in the corpus to multiple offline clusters, and such assigning is not limited to using any particular clustering algorithm or input configuration to determine the multiple offline clusters.

For example, by using the same or different clustering mechanisms with the same or different similarity thresholds, a particular article that is related to a news story about the Haiti earthquake may be assigned to multiple offline clusters. For example, the article may be assigned to belong to: a first offline cluster that includes articles about the Haiti earthquake in general; a second offline cluster that includes articles about rescue efforts in the aftermath of the Haiti earthquake; and third offline cluster that includes articles about aftershocks in the Haiti earthquake. Thus, each article in the corpus can be assigned to multiple offline clusters depending on the granularity and/or the mechanism by which similarities between the articles in the corpus are determined.

### Feature Vector Generation

A typical article includes several components such as a title, a small abstract (provided by the publisher or author), and a body of the article. (An article may also have include portions and components that we are not of interest with regards to clustering such as, for example, advertisements, header, footer, etc.) The title, abstract, and body of an article typically include content in the form of natural language text, where various portions of this text can be used as various types of features to determine the similarity of the article to the content of other articles for the purpose of clustering.

As used herein, “feature” refers to information that is included in, or is associated with, an article. For example, features of an article may include, without limitation, a word from the title, abstract, or body of the article, a sequence of words from the article, metadata information (e.g., such as publication date, publisher name, etc.) about or associated with the article, and any other type of data that characterizes the properties and/or content of the article in some way. A named entity (possibly having multiple words, e.g., such as “White House”) mentioned in an article can also be used as a feature for that article. As used herein, “unigram” refers to a single word that is used as a feature; similarly, “bigram”, “trigram”, and “n-gram” refer to two-word, three-word, and n-word sequences of words (possibly, but not necessarily, phrases) that are used as features. For example, in the phrase “architecture of the system”: “architecture”, “of”, “the”, and “system” are unigrams; “architecture of”, “of the”, and “the system” are bigrams; “architecture of the” and “of the system” are trigrams, etc.

The accuracy of offline clustering depends at least in part on the underlying similarity function that is used to construct the similarity graph. As discussed above, a poorly designed similarity function can either merge the articles related to different news stories into the same cluster, or can split the articles related to the same news story into many clusters.

In addition, it was experimentally determined that the accuracy of clustering (offline as well as online) is increased if features from the bodies of the articles are used in the clustering. In some embodiments, the features from various portions of an article can be weighted differently when using feature vectors representing the articles during clustering (offline as well as online). For example, a weighting function can be used in order to assign more weight to features from a title of an article, less weight to features from the abstract of the article, and least weight to features from the body of the article (since the body features are the most numerous). It is noted that in practice, conventional clustering mechanisms typically use only features from the titles and abstracts of the articles being clustered because processing the body features of the articles is computationally very expensive. However, since experimental results show that the use of body features increases the accuracy of clustering, the techniques described herein provide for using body features during offline clustering that is performed on a corpus of articles, and then using the offline cluster identifiers assigned to the articles as proxies for body features during online clustering performed on a set of articles that is included in the result for a user query.

In an example embodiment, additional types of features that can be used to define a custom similarity function. In such an embodiment, feature vectors used during offline clustering include:
TF-IDF values: the TF-IDF values can be used to construct a unigram-based feature vector for the words in a news article after stop-word removal and stemming;
Wikipedia Topics: Wikipedia topics can be extracted from a news article using techniques that rely on informatively named entities. Each extracted Wikipedia topic can then be assigned an “aboutness score” which represents how important that topic is to the article. A ranked list based on the aboutness scores for the extracted Wikipedia topics can then be used as a feature vector for the article, where the feature values in the vector correspond to the aboutness scores;
Part of Speech Tagging: a news article can be tagged with a Part-of-Speech tagger. Unigrams can be extracted from nouns, adjectives, and verbs included in the article. The extracted unigrams can then be used as features, where the frequencies of the unigrams in the article are used as the feature values.

In addition to the above types features that can be used to construct feature vectors, an example embodiment makes use of presentation cues associated with a news article to emphasize certain phrases or unigrams such as the fact that a phrase appears in the title, or abstract, or is italicized, etc. The different types of features discussed above are assigned a score based on their presentation in the news article. The features from the three different channels (e.g., title, abstract, and body of the article) are then combined through a simple aggregation of weights assigned to unigrams from each channel. The constructed feature vector is then unit-normalized before being used to compute a cosine similarity to another feature vector of another news article.

In one example embodiment, time is another feature that is used to construct a feature vector during offline clustering. A news article is typically associated with a timestamp that indicates when the article was initially published. Given two articles that are published on days t₁ and t₂, the cosine similarity on the custom feature space can be weighted by using the weighting function

$${e}^{- \frac{\vert {t}_{1} - {t}_{2} \vert}{7} .}$$

This weighting function indicates that the closer the dates of publication of the two articles, the more likely the two articles are to be similar. Since a news story cluster typically should not contain any articles that are apart by more than a week, the above weighting function decreases the similarity between such pairs of articles.

### Locality Sensitive Hashing (LSH)

While it is relatively easy to compute feature vectors for all pairs of a small set of articles and to compare the computed feature vectors, such pair-wise vector computation and comparison becomes computationally expensive for larger corpora. A corpus with 100,000 articles requires 10,000,000,000 such comparisons. However, once an article has been mapped into its feature space and a feature vector representing the article has been computed, the chances of a pair of completely unrelated articles sharing any useful features is quite low. It is therefore unnecessary to explicitly compute the pair-wise similarity between pairs of articles that do not share any useful features. For this reason, according to the techniques described herein, a LSH mechanism is used to eliminate unnecessary similarity computations.

While the comparison to determine the similarity values between all pairs of articles in a corpus is of O(N²) order, pairs of articles that are unrelated are likely to have very low similarity values that need be explicitly computed. Thus, an LSH-based mechanism can be used to quickly eliminate, from the pair-wise similarity computations, those pairs of articles that share very few features.

In an example embodiment, during offline clustering, a shorter LSH signature is constructed for each article by concatenating a smaller set of minhash signatures that are computed for the article. This process of computing a shorter LSH signature is repeated 200 times for each article. Then, articles which contain at least a few words in common are likely to agree in at least one of their LSH signatures. Thus, the LSH mechanism is used to select for further processing (e.g., for similarity value computations) only those pairs of articles that have the at least one common LSH signature. In the example embodiment, the LSH mechanism is configured to generate, for each article, 200 LSH signatures of 2-byte lengths. (It is noted that LSH mechanism is not limited to being configured with these particular settings.) Experimental results show that this configuration of the LSH mechanism enabled the discovery of 96% of all pairs of similar articles as compared to a complete full-blown pair-wise comparison between the same corpus of articles.

In an example embodiment, after the LSH mechanism is used to eliminate the pairs of articles that are not likely to be related (e.g., those pairs of articles that do not share at least one LSH signature), pair-wise similarity values are computed on all the remaining pairs of articles in the corpus. The computed similarity values are cosine similarity values that are computed on unit-normalized feature vectors that represent the articles. The computed cosine similarity values are further weighted with the time information as described in the preceding section. Then, only those pairs of articles whose similarity exceeds a pre-configured threshold value are recorded, and a similarity graph is then constructed using the output of the LSH mechanism and the recorded pairs of articles. In the graph, each article is represented as a node and an edge is added between any two nodes if the similarity value between the articles represented by these two nodes exceeds the pre-defined threshold value. The edges may also be weighted by the corresponding cosine similarity value.

### Offline Clusters

According to the techniques described herein, a unique cluster identifier is assigned or mapped to each offline cluster that is determined by the offline clustering over the corpus of articles. Then, one or more cluster identifiers are assigned to each article in the corpus of articles, where the cluster identifiers assigned to a particular article identify those offline clusters to which the particular article belongs as determined by the offline clustering.

In different embodiments, a numeric or alphanumeric value of any suitable datatype can be used as a cluster identifier to uniquely identify a particular offline cluster. Further, in different embodiments and implementations, the cluster identifier(s) that are assigned to a particular article may be stored in association with the article (and/or with an article identifier thereof) in any suitable way. For example, the cluster identifier(s) assigned to an article may be stored as one or more fields in one or more index entries that represent the article in a search index. In another example, the cluster identifier(s) assigned to an article may be stored as one or more fields in one or more records that represent the article in one or more database tables. In yet another example, the cluster identifier(s) assigned to an article may be stored in one or more directory entries that represent the article in a directory. Thus, the techniques described herein are not limited to any particular way of associating offline cluster identifiers with the articles in a corpus; rather, offline cluster identifiers can be associated with articles by using any suitable types of data structures that are stored in any suitable types of data repositories.

According to the techniques described herein, each article in the corpus may be assigned to belong to multiple different offline clusters that may be determined by using the same or different clustering mechanisms with the same or different similarity thresholds. In this manner, the techniques described herein provide for assigning each article in the corpus to multiple different offline clusters that represent multiple different granularities and levels of detail for the content of the articles in the corpus.

For example, to generate offline clusters, an offline clustering component may use features from the titles, abstracts, and bodies of the articles in the corpus. To generate offline clusters of different granularities, the offline clustering component may use a particular clustering mechanism with different threshold values—e.g., to determine offline clusters at a coarser level of granularity, a threshold value of 0.70 may be used, and to determine offline clusters at a finer level of granularity, a different threshold value of 0.80 may be used. As a result, at the coarse level of granularity, a certain group of articles can belong to the same offline cluster (e.g., articles A1, B1, C1, and D1 all belong to the same offline cluster X). Concurrently, at the finer lever of granularity, the same group of articles may be grouped to belong into different offline clusters (e.g., articles A1 and D1 belong to offline cluster Y, and articles B1 and C1 belong to offline cluster Z).

### Search Result Generation

According to the techniques described herein, offline cluster identifiers that are assigned to the articles in a corpus are used, during online clustering, as proxies for features from the bodies of those articles that are selected as the search result for a search query.

In an example embodiment, the search result for a query may be generated as follows. Through a web page or other interface provided by a search engine, the search engine receives a query that specifies one or more search criteria against a corpus of articles. For example, the search engine may receive the query from a web browser in which a user has entered one or more search terms (e.g., words, phrases, etc.) that comprise the search criteria of the query. In response to receiving the query, the search engine generates a search result for the query based on the search criteria specified in the query. In an example implementation, the search engine performs a search against a search index in order to identify those articles, from the corpus of articles, which match or are relevant to the search terms specified in the query. The search engine then uses a ranking function to rank each identified article, and selects a certain set (e.g., such as the top N) of the identified articles as the search result for the query. In the search result, the selected articles are assigned ranks by the ranking function, where the rank assigned to a particular article indicates how relevant the particular article is to the received query when compared to the other articles in the search result.

The search result generated by the search engine is stored in an in-memory representation that is suitable for identifying articles, where the in-memory representation stores information that identifies each article included in the search result (e.g., such as article ID, URL, etc.) as well as other information about each article (e.g., such as rank, short summary, etc). For example, the in-memory representation of the search result may be an object instantiated from an object-oriented class, a table instantiated in memory, or any other type of volatile memory data structure that is suitable for storing information about search results. According to the techniques described herein, the in-memory representation of the search result is passed and/or otherwise sent to an online clustering component that performs online clustering on the articles identified by the search result before the search result is returned to the user's browser.

### Online Clustering of Search Results

According to the techniques described herein, after the articles in the search result for a query have been selected from a corpus of articles, online clustering is performed on the selected articles. The online clustering determines one or more online clusters for the articles in the search result by using the offline cluster identifiers, which are assigned to the search result articles, as proxies for the body features of these articles. Further, the online clustering uses the offline cluster identifiers in addition to using features that are extracted from the titles and abstracts of the articles identified in the search result. The search result is then formatted according to the determined online clusters by using any appropriate spacing and indentation, and the formatted search result is then returned to the web browser which sent the query.

In an example embodiment, the offline cluster identifiers, which are assigned to the articles in a search result for a query, are used as additional features into the feature vectors that are generated for an online clustering component. In computing the similarity values for the pairs of articles in the search result, the online clustering component uses these offline cluster identifiers to determine the closeness of the two articles in each pair based on whether the two articles have similar offline cluster identifiers. It is noted that since the offline clustering may determine that an article belongs to multiple offline clusters that have different granularity levels, the article can be assigned multiple offline cluster identifiers.

In order to determine the online clusters, in an example embodiment, an online clustering component receives or otherwise accesses the in-memory representation of the search result for a particular query. According to this example embodiment, the online clustering component is configured to: (a) utilize a hierarchical agglomerative clustering (HAC) mechanism over features from the titles and abstracts of the articles in the search result to compute cosine similarity values for each pair of articles in the search result; and (b) utilize a Jaccard mechanism over the offline cluster identifiers assigned to the articles in the search result to compute Jaccard similarity values for the pairs of articles in the search result. Then, for each particular pair of articles in the search result, the online clustering component computes a final similarity measure “Sim” as follows:

Sim=α*Cosine Sim+(1−α)*JaccardSim

where “Cosine Sim” is the cosine similarity value computed for the particular pair of articles, “JaccardSim” is the Jaccard similarity value computed for the same particular pair of articles, and “α” is a weight parameter indicating the relative weights assigned to cosine similarity values and the Jaccard similarity values. In an example implementation, α=0.5 may represent a good tradeoff that balances the relative importance of the title and abstract features as reflected in the cosine similarity values and of the body features as reflected in the offline cluster identifiers. The online clustering component uses the final similarity value for each pair in order to determine the final online clusters according to which the articles in the search result are to be grouped.

In an example implementation, the cosine similarity value for a pair of articles may be computed as the cosine of the angle between the two feature vectors that represent the two articles in the pair. The cosine similarity value for a pair of articles would be equal to 1.0 when the features in the corresponding two feature vectors are identical (e.g., when the angle between the two feature vectors is 0 degrees). The cosine similarity value for the pair of articles would be equal to 0.0 when the corresponding two feature vectors contain completely different features (e.g., when the angle between the two feature vectors is 90 degrees). A cosine similarity value between 1.0 and 0.0 can thus indicate how similar is the content of two articles as represented by the features included in the feature vectors of these two articles.

In an example implementation, the Jaccard similarity value for a pair of articles may be computed as follows:

$$Jaccard ( {C}_{1} , {C}_{2} ) = \frac{{C}_{1} ⋂ {C}_{2}}{{C}_{1} ⋃ {C}_{2}}$$

where C₁ and C₂ are the corresponding vectors of the offline cluster identifiers for the two articles in the pair. For example, when feature vector C₁ includes the offline cluster identifiers ID1, ID3, ID4, ID5, and ID6 (e.g., vector C₁={ID1, ID3, ID4, ID5, ID6}), and feature vector C₂ includes the offline cluster identifiers ID1, ID2, ID3, ID4, ID5 (e.g., vector C₂={ID1, ID2, ID3, ID4, ID5}), then the Jaccard similarity value between the vectors C₁ and C₂ is 4/6=0.67 since

C₁∩C₁={ID1,ID3,ID4,ID5}has 4 members, and

C₁∪C₁={ID1,ID2,ID3,ID4,ID5,ID6}has 6 members.

### Search Result Formatting

According to the techniques described herein, the articles selected in the search result for a query are grouped according to the online clusters determined by the online clustering. The search result thusly formatted is then returned to the web browser or other program that issued the query.

In an example embodiment, the search result for a query is included in a web page that is dynamically generated by a search engine and/or components thereof in response to the query. The search result includes URL links to the articles that have been selected as matching, or relevant to, the search criteria specified in the query. In addition to the URL links, the search result may also include additional attributes of the selected articles such as, for example, a short summary, a name of the publisher, a date and time of publication, a thumbnail image, and any other article attributes that may be displayed for the benefit of a human user.

According to the techniques described herein, the web page returned to the user is formatted in such way that URL links to articles (and other attributes thereof) that belong to the same online cluster are displayed as a group in the user's browser. The formatting of the web page may be automatically generated by using indentation, spacing, fonts, and any other graphical user interface (GUI) and display properties to organize the URL links of the search result articles (and other attributes thereof) according to the online clusters that are determined by the online clustering.

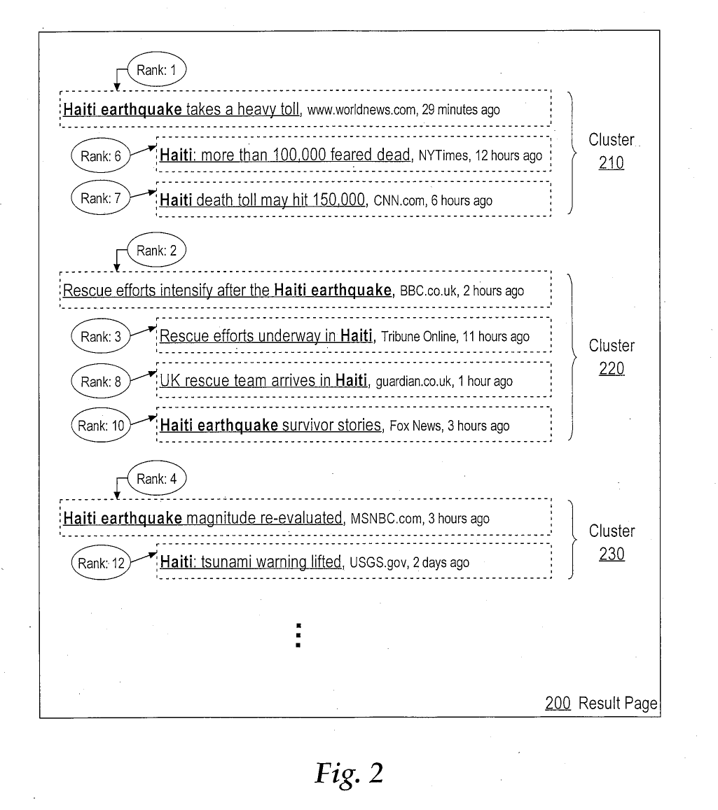

FIG. 2 is a block diagram that illustrates an example of a search result that has been formatted according to one embodiment of the techniques described herein. The search result illustrated in FIG. 2 is determined in response to a search query that included the search terms “Haiti earthquake”. (It is noted that for illustration purposes, the URL links in FIG. 2 are displayed in an “underline” font, and the terms that match the search criteria exactly are displayed in a “bold” font.)

As illustrated in FIG. 2, the search result in page 200 is grouped at least into clusters 210, 220, and 230, which have been determined according to the techniques described herein. The URL links to the articles in the clusters are visualized as separate groups by using spacing and indentation, such that each cluster has one lead URL link that is indented further to the left than the other URL links in this cluster.

For example, in cluster 210 the lead URL link

“Haiti earthquake takes a heavy toll”

is indented further to the left than the other URL links in this cluster; as is apparent from its URL links, cluster 210 pertains to a news story that relates to the death toll of the Haiti earthquake. Similarly, in cluster 220 the lead URL link

“Rescue efforts intensify after the Haiti earthquake”

is indented further to the left than the other URL links in this cluster; as is apparent from its URL links, cluster 220 pertains to a news story that relates to the rescue efforts in the aftermath of the Haiti earthquake. In cluster 230, the lead URL link

“Haiti earthquake magnitude re-evaluated”

is indented further to the left than the other URL links in this cluster; as is apparent from its URL links, cluster 230 pertains to a news story that relates to the magnitude of the Haiti earthquake.

In some embodiments, in addition to grouping the articles in a search result according to the determined online clusters, the techniques described herein provide for preserving as much as possible the ranks assigned by a ranking function to the articles in the search result. For example, in these embodiments the search result articles belonging to the same cluster are grouped together in the web page, where the highest ranked article of each cluster appears as the lead article at the top of that cluster, and where the cluster containing the highest ranked article appears at the top of the web page followed by the cluster containing the next highest ranked lead article and so on.

Result page 200 in FIG. 2 illustrates an organization, according to an example embodiment, that preserves the ranks assigned by a ranking function to the articles in a search result. In FIG. 2, the rank assigned to each article is illustrated as a number in an oval. (It is noted, however, that the ranks are shown in FIG. 2 for illustrative purposes only; in a real search result web page, the rank assigned to each article is typically not displayed to the user.) As illustrated in FIG. 2, the lead article of cluster 210 has a rank of 1, and for this reason cluster 210 is arranged at the top of page 200 and the URL to this lead article is arranged at the top of the cluster. Cluster 220 includes the lead article with the next highest rank of 2, and for this reason cluster 220 is arranged on page 200 below cluster 210. Similarly, cluster 230 includes the lead article with the next highest rank of 4, and for this reason cluster 230 is arranged on page 200 below cluster 220.

### Structural Description of an Example Embodiment

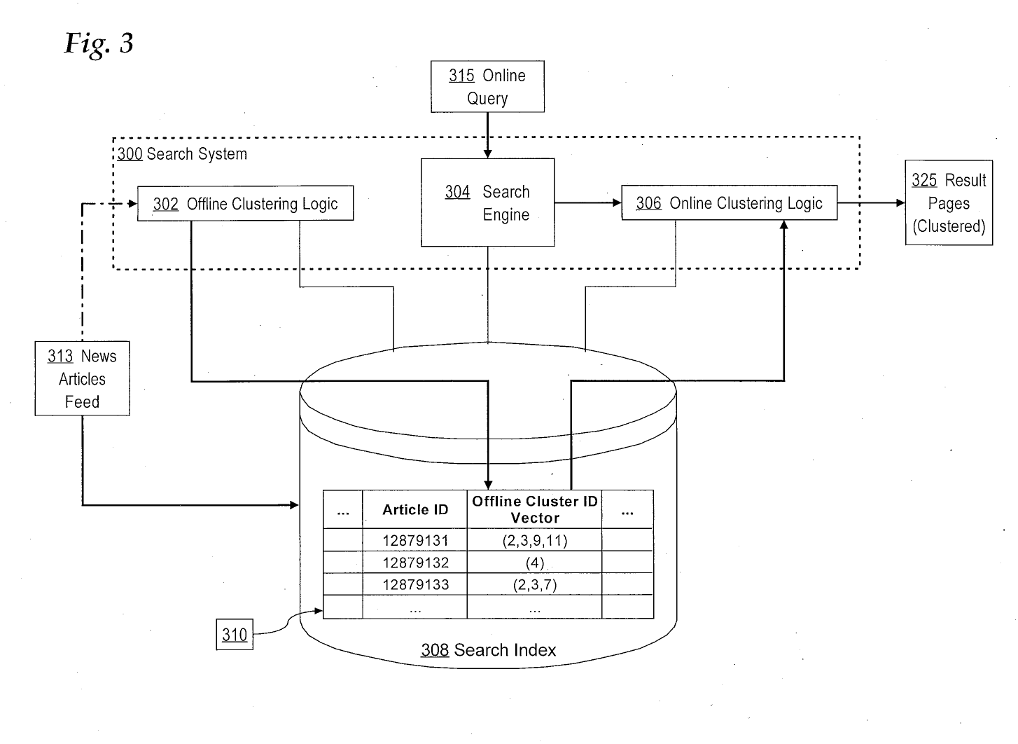

FIG. 3 is a block diagram that illustrates an example operational context according to one embodiment. Offline clustering logic 302, search engine 304, and online clustering logic 306 are configured to execute on one or more computing devices (not shown) that are included in search system 300. In some embodiments, search system 300 may be a distributed system in which various system components are executed on separate hardware hosts and devices. It is noted, however, that the techniques described herein are not limited to being implemented in any particular type of system, and for this reason the search system 300 in FIG. 3 is to be regarded in an illustrative rather than a restrictive sense.

As used herein, “logic” refers to a set of executable instructions which, when executed by one or more processors, are operable to perform one or more functionalities. In various embodiments and implementations, any such logic may be implemented as one or more software components that are executable by one or more processors, as one or more hardware components such as Application-Specific Integrated Circuits (ASICs) or other programmable Integrated Circuits (ICs), or as any combination of software and hardware components.

In the example embodiment of FIG. 3, offline clustering logic 302 and online clustering logic 306 are implemented as one or more software components that are communicatively and/or operably coupled to search engine 304. Offline clustering logic 302 is configured to perform offline clustering according to the techniques described herein, and online clustering logic 306 is configured to perform online clustering according to the techniques described herein. Search engine 304 includes logic implemented as one or more software components that perform one or more functionalities that include, but are not limited to, crawling one or more public and/or private networks to locate content stored on network nodes therein, indexing the located content into one or more search indexes, and responding to user queries based on the search indexes.

Offline clustering logic 302, search engine 304, and online clustering logic 306 are communicatively coupled to search index 308. Search index 308 is a collection of index data that is stored on one or more persistent storage devices, where the collection of index data includes the articles (and/or representations of the content thereof) that comprise a news corpus. It is noted that in various embodiments and implementations, the collection of data comprising a search index may be stored on persistent storage devices as one or more structured data files, as one or more relational databases, as one or more object-relational databases, and/or as any other type of data repository that is suitable for storing the index data for responding to web searches.

As illustrated in FIG. 3, search index 308 includes table 310 that stores records representing the articles of the corpus stored in the search index. In table 310, each record representing an article is configured to include at least a field for storing an article ID of the represented article and, according to the techniques described herein, a field for storing the vector of offline cluster IDs of the offline clusters to which the represented article belongs.

In operation, search system 300 or component(s) thereof receive or otherwise access news articles feed 313. Feed 313 may comprise RSS data feeds from various news sources (e.g., such as Associated Press, Reuters, etc.), where news articles are included in the RSS feeds as XML (or other markup language) elements. In the example embodiment illustrated in FIG. 3, the articles in feed 313 may be processed, indexed, and stored (in their entirety or only representations thereof) in search index 308 by various components in search system 300 such as, for example, search engine 304.

Offline clustering logic 302 performs offline clustering on the corpus of articles represented in search index 308 in accordance with the techniques described herein. For example, offline clustering logic 302 accesses the articles in the corpus and determines the offline clusters to which the articles in the corpus belong. Offline clustering logic 302 performs the offline clustering periodically (e.g., every 2 hours during the day, every night, etc.) against substantially the whole corpus of articles. In some implementations, the offline clustering logic may be configured to perform the offline clustering incrementally in response to determining that one or more new articles have been added to the corpus.

According to the techniques described herein, offline clustering logic 302 assigns or maps a unique offline cluster identifier to each offline cluster that is determined. As part of offline clustering, offline clustering logic 302 assigns to each article in the corpus the cluster identifiers of those offline clusters to which that article belongs, and persistently stores these offline cluster identifiers in search index 308 in association with that article. For example, as illustrated in FIG. 3, offline clustering logic 302 stores the offline cluster ID vector (2,3,9,11) in a field of the record in table 310 that represents the article identified by article ID 12879131. Similarly, offline clustering logic 302 stores the offline cluster ID vector (4) in a field of the record in table 310 that represents the article identified by article ID 12879132, and also stores the offline cluster ID vector (2,3,7) in a field of the record in table 310 that represents the article identified by article ID 12879133.

In operation, search engine 304 receives online query 315 that specifies one or more search terms against the corpus of news articles represented in search index 308. According to the techniques described herein, search engine 304 generates a search result for query 315 by performing a search against search index 308 in order to identify those articles that match or are relevant to the search terms specified in the query. Search engine 304 then uses a ranking function to rank each identified article, and selects a certain set of the identified articles as the search result for the query. Search engine 304 then generates an in-memory representation of the search result and passes the in-memory representation to, or otherwise invokes, online clustering logic 306.

Online clustering logic 306 performs online clustering based on the in-memory representation of the search result in accordance with the techniques described herein. Specifically, online clustering logic 306 accesses table 310 in search index 308 and retrieves the offline cluster ID vectors for the articles identified in the in-memory representation of the search result. Online clustering logic 306 (or a component thereof) then builds a feature vector for each search result article, where the feature vector includes features from the title and abstract of that article and the offline cluster IDs that have been assigned to that article by offline clustering logic 302.

In accordance with the techniques described herein, for each pair of articles in the search result, online clustering logic 306 uses the feature vectors corresponding to the articles to compute a final similarity value for that pair. For example, online clustering logic 306 uses the title and abstract features from the two feature vectors corresponding to the articles in the pair to compute a cosine similarity value for that pair, uses the offline cluster IDs from the two feature vectors to compute a Jaccard similarity value for that pair, and then generates the final similarity value for that pair based on the computed cosine similarity value and Jaccard similarity value. Online clustering logic 306 then uses the set of final similarity values computed for all pairs of articles in the search result to determine the final online clusters according to which the articles in the search result are going to be organized for displaying to the user.

Online clustering logic 306 (or a component associated therewith) then dynamically generates result web pages 325 and, by using suitable indentation and spacing, formats result pages 325 so that URL links to the search result articles that belong to the same online cluster are displayed together as a group. Online clustering logic 306 (or another component associated with search engine 304) then returns the generated result pages 325 to the web browser or other program that sent query 315 to the search engine.

### Evaluation of a Prototype Embodiment

A prototype embodiment according to the techniques described herein was implemented and the performance thereof was evaluated against a corpus that included approximately 25,000 news articles. The accuracy of the online clustering indicated in Tables 1 and 2 below is represented by the averaged Q4 outcomes that were computed for each configuration indicated in the tables over several hundred queries.

Table 1 provides the Q4 values obtained for various combinations of features by using the identified online clustering mechanisms.

| Line | Algorithm Description | Avg Q4 |
|---|---|---|
| 1 | Best Single Offline Clustering | 0.7340 |
| 2 | Title + Abstract Features Only | 0.7584 |
| 3 | Title + Abstract + Best Offline Set of Clusters | 0.7801 |
| 4 | Title + Abstract + Body Features | 0.8157 |
| 5 | Title + Abstract + Body + Best Offline Set of Clusters | 0.8208 |

In Table 1, Line 1 indicates online clustering that uses only offline cluster identifiers to group the articles in search results for online queries, and Line 2 indicates online clustering that uses features only from the titles and abstracts of the articles identified in the search results for the online queries. Line 3 indicates online clustering according to the techniques described herein that uses features from the titles and the abstracts of the articles indicated in a search result and offline cluster identifiers that were assigned to these articles by an offline clustering mechanism. As can be seen from Table 1, the clustering mechanism used for Line 3 clearly achieves better online clustering accuracy as compared with mechanism used for Line 2. This is at least because the mechanism used for Line 3 uses offline cluster identifiers as proxies for features from the bodies of the articles identified in the search result for an online query, thereby providing a significant improvement over the mechanisms used for both Lines 1 and 2. It is noted that while the mechanisms used for Lines 4 and 5 provide slightly better online clustering accuracy, these mechanisms are not practical because using body features in online clustering is computationally expensive and simply takes too long to be feasible for responding to a user query in real-time.

Table 2 provides the Q4 values obtained for online clustering that uses various numbers of offline cluster identifiers.

| Line | Offline Cluster Sets | Avg Q4 |
|---|---|---|
| 1 | (1, 2, 3) | 0.78009 |
| 2 | (1, 2) | 0.77686 |
| 3 | (1, 3) | 0.77444 |
| 4 | (1) | 0.77418 |
| 5 | (2) | 0.77130 |
| 6 | (2, 3) | 0.77036 |
| 7 | (3) | 0.76155 |

Table 2 compares the accuracy of online clustering when offline clustering produces single and multiple offline clusters (in the indicated combinations). In Table 2, Line 1 shows that when offline clustering uses different levels of granularity (e.g., by using the same clustering mechanism with different threshold values) or different clustering mechanisms to determine multiple offline clusters per article, the accuracy of the online clustering that uses the offline cluster identifiers as features is significantly improved.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, network infrastructure devices, or any other device that incorporates hard-wired and/or program logic to implement the techniques.

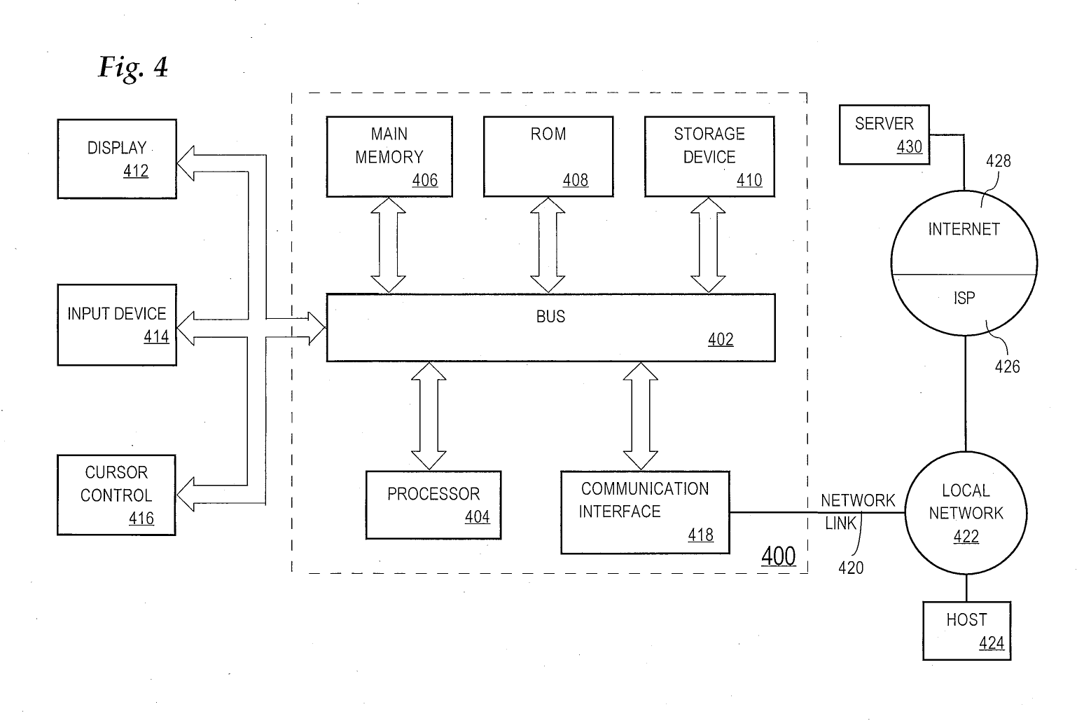

For example, FIG. 4 is a block diagram that illustrates a computer system 400 upon which an embodiment of the techniques described herein may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT) or a liquid crystal display (LCD), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques for clustering of search results described herein by using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
determining a plurality of first clusters in a corpus of articles, wherein each of the plurality of first clusters represents a group of articles that relate to a news story;
wherein determining the plurality of first clusters is performed independently of user queries issued against the corpus of articles;
assigning one or more cluster identifiers to each article in the corpus of articles, wherein the one or more cluster identifiers respectively identify one or more of the plurality of first clusters to which said each article belongs;
receiving a query that specifies one or more search criteria against the corpus of articles;
in response to receiving the query, generating a result for the query by at least selecting, from the corpus of articles, a set of articles based on the one or more search criteria specified in the query;
grouping the set of articles into one or more second clusters based at least on the one or more cluster identifiers that are assigned to each article in the set of articles; and
in the result for the query, organizing the set of articles according to the one or more second clusters;
wherein the method is performed by one or more computing devices.

2. The method of claim 1, wherein determining the plurality of first clusters comprises using a locality sensitive hashing (LSH) mechanism to compute similarity values between pairs of articles, from the corpus of articles, based on information from the title, the abstract, and the body of each article in the pairs of articles.

3. The method of claim 1, wherein assigning the one or more cluster identifiers to said each article comprises assigning multiple cluster identifiers to at least one article, in the corpus of articles, wherein the multiple cluster identifiers respectively identify multiple different clusters.

4. The method of claim 3, wherein assigning the multiple cluster identifiers to said at least one article comprises determining the multiple different clusters by using a particular clustering mechanism based on multiple different similarity thresholds.

5. The method of claim 3, wherein assigning the multiple cluster identifiers to said at least one article comprises determining the multiple different clusters by using at least two different clustering mechanisms that identify clusters in different ways.

6. The method of claim 1, wherein grouping the set of articles into the one or more second clusters further comprises:
in addition to using the one or more cluster identifiers that are assigned to said each article in the set of articles, using information from the titles and the abstracts of the articles in the set of articles.

7. The method of claim 1, wherein grouping the set of articles into the one or more second clusters further comprises using a hierarchical agglomerative clustering (HAC) mechanism to compute cosine similarity values between pairs of articles, from the set of articles, based on information from the titles and the abstracts of the articles in the pairs of articles.

8. The method of claim 1, wherein grouping the set of articles into the one or more second clusters comprises:
computing a set of Jaccard similarity values based on the one or more cluster identifiers that are assigned to said each article in the set of articles; and
determining the one or more second clusters based at least on the set of Jaccard similarity values.

9. The method of claim 1, wherein grouping the set of articles into the one or more second clusters comprises:
for each pair of articles from the set of articles, computing a final similarity value as a sum of a weighted cosine similarity value and a weighted Jaccard similarity value; and
determining the one or more second clusters based on the final similarity values that are computed for the pairs of articles from the set of articles.

10. The method of claim 9, wherein for said each pair of articles from the set of articles:
the weighted cosine similarity value is computed by using, as inputs to a hierarchical agglomerative clustering (HAC) mechanism, features from one or more of the title and the abstract of each article in said each pair of articles; and
the weighted Jaccard similarity value is computed by using the one or more cluster identifiers that are assigned to each article in said each pair of articles.

11. The method of claim 1, wherein grouping the set of articles into the one or more second clusters comprises:
including, into a feature vector representing said each article in the set of articles, the one or more cluster identifiers that are assigned to said each article; and
determining the second one or more clusters based on the feature vectors that represent the articles in the set of articles.

12. A non-transitory computer-readable storage medium comprising one or more sequences of instructions which, when executed by one or more processors, cause the one or more processors to perform:
determining a plurality of first clusters in a corpus of articles, wherein each of the plurality of first clusters represents a group of articles that relate to a news story;
wherein determining the plurality of first clusters is performed independently of user queries issued against the corpus of articles;
assigning one or more cluster identifiers to each article in the corpus of articles, wherein the one or more cluster identifiers respectively identify one or more of the plurality of first clusters to which said each article belongs;
receiving a query that specifies one or more search criteria against the corpus of articles;
in response to receiving the query, generating a result for the query by at least selecting, from the corpus of articles, a set of articles based on the one or more search criteria specified in the query;
grouping the set of articles into one or more second clusters based at least on the one or more cluster identifiers that are assigned to each article in the set of articles; and
in the result for the query, organizing the set of articles according to the one or more second clusters.

13. The non-transitory computer-readable storage medium of claim 12, wherein the instructions that cause determining the plurality of first clusters comprise instructions which, when executed by the one or more processors, cause the one or more processors to perform using a locality sensitive hashing (LSH) mechanism to compute similarity values between pairs of articles, from the corpus of articles, based on information from the title, the abstract, and the body of each article in the pairs of articles.

14. The non-transitory computer-readable storage medium of claim 12, wherein the instructions that cause assigning the one or more cluster identifiers to said each article comprise instructions which, when executed by the one or more processors, cause the one or more processors to perform assigning multiple cluster identifiers to at least one article, in the corpus of articles, wherein the multiple cluster identifiers respectively identify multiple different clusters.

15. The non-transitory computer-readable storage medium of claim 14, wherein the instructions that cause assigning the multiple cluster identifiers to said at least one article comprise instructions which, when executed by the one or more processors, cause the one or more processors to perform determining the multiple different clusters by using a particular clustering mechanism based on multiple different similarity thresholds.

16. The non-transitory computer-readable storage medium of claim 14, wherein the instructions that cause assigning the multiple cluster identifiers to said at least one article comprise instructions which, when executed by the one or more processors, cause the one or more processors to perform determining the multiple different clusters by using at least two different clustering mechanisms that identify clusters in different ways.

17. The non-transitory computer-readable storage medium of claim 12, wherein the instructions that cause grouping the set of articles into the one or more second clusters further comprise instructions which, when executed by the one or more processors, cause the one or more processors to perform:
in addition to using the one or more cluster identifiers that are assigned to said each article in the set of articles, using information from the titles and the abstracts of the articles in the set of articles.

18. The non-transitory computer-readable storage medium of claim 12, wherein the instructions that cause grouping the set of articles into the one or more second clusters further comprise instructions which, when executed by the one or more processors, cause the one or more processors to perform using a hierarchical agglomerative clustering (HAC) mechanism to compute cosine similarity values between pairs of articles, from the set of articles, based on information from the titles and the abstracts of the articles in the pairs of articles.

19. The non-transitory computer-readable storage medium of claim 12, wherein the instructions that cause grouping the set of articles into the one or more second clusters comprise instructions which, when executed by the one or more processors, cause the one or more processors to perform:
computing a set of Jaccard similarity values based on the one or more cluster identifiers that are assigned to said each article in the set of articles; and
determining the one or more second clusters based at least on the set of Jaccard similarity values.

20. The non-transitory computer-readable storage medium of claim 12, wherein the instructions that cause grouping the set of articles into the one or more second clusters comprise instructions which, when executed by the one or more processors, cause the one or more processors to perform:
for each pair of articles from the set of articles, computing a final similarity value as a sum of a weighted cosine similarity value and a weighted Jaccard similarity value; and
determining the one or more second clusters based on the final similarity values that are computed for the pairs of articles from the set of articles.

21. The non-transitory computer-readable storage medium of claim 20, wherein for said each pair of articles from the set of articles:
the weighted cosine similarity value is computed by using, as inputs to a hierarchical agglomerative clustering (HAC) mechanism, features from one or more of the title and the abstract of each article in said each pair of articles; and
the weighted Jaccard similarity value is computed by using the one or more cluster identifiers that are assigned to each article in said each pair of articles.

22. The non-transitory computer-readable storage medium of claim 12, wherein the instructions that cause grouping the set of articles into the one or more second clusters comprise instructions which, when executed by the one or more processors, cause the one or more processors to perform:
including, into a feature vector representing said each article in the set of articles, the one or more cluster identifiers that are assigned to said each article; and
determining the second one or more clusters based on the feature vectors that represent the articles in the set of articles.
